(19) United States
(12) Patent Application Publication
(10) Pub. No.: US 2006/0107896 A1
(43) Pub. Date: May 25, 2006

(54) Mask

(76) Inventor: Hugh Frederick Buckingham, Merseyside (GB)

Correspondence Address: CLARK & BRODY, 1090 VERMONT AVENUE, NW, SUITE 250, WASHINGTON, DC, 20005, US

(21) Appl. No.: 10/995,195

(22) Filed: Nov. 24, 2004

(51) Int. Cl. B05C 11/11

(52) U.S. Cl. 118/504; 118/505

(57) ABSTRACT

A mask is disclosed for use in painting of a motor vehicle wheel of the type comprising a hub, which is to be painted, and a tyre disposed upon the hub. The mask comprises at least two mask panels 2, each having a concave arcuate inner edge 4. The individual panels can be arranged together around the wheel hub 8 with their inner edges 2 lying adjacent and conforming to the rim of the wheel hub. Together the mask panels 2 therefore form a ring around that rim, covering at least part of the tyre wall and so protecting it from inadvertent application of paint. At least a radially inner region of each mask panel is self adhesive and is covered by removable backing panel 14. Removal of the backing panel exposes the adhesive in this region and through this the mask panel can be adhered to the tyre wall. However, it leaves a non-adhesive outer region 14 through which the mask panel is able to be handled by the user during its fitting. The potentially awkward process of fitting the mask is thereby facilitated.

The present invention relates to masks for use in painting of motor vehicle wheel hubs.

### BACKGROUND OF THE INVENTION

It is a common practice when restoring motor vehicles to paint outer surfaces of the metal part of the wheel carrying the tyre (to be referred to herein as the “wheel hub”) in order to renew its appearance. Painting can of course be done by brush or, more typically, by spray. In either case however, if a tyre is in place upon the wheel hub, then it needs to be masked to keep the paint off the tyre itself. Masking can be done with self adhesive tape, applied to the wall of the tyre adjacent the rim of the wheel hub, but to make the tape conform to the curve of the wheel rim is in practice awkward if not impossible. Multiple short strips of tape may instead be applied, to collectively approximate to the curve of the wheel rim, but applying these is time consuming and, with multiple overlapping joins in the tape mask, there is an increased risk of having paint creep beneath it.

### PRIOR ART

A great improvement is provided by the type of mask disclosed in the Applicant's United Kingdom Patent Application GB 2305621, which is formed from multiple self-adhesive panels each of arcuate shape. These are arranged together in use to form a ring around the wheel hub, the radius of curvature of the inner edges of the panels being chosen to match, at least approximately, the curvature of the rim of the wheel hub. In use the panels are adhered to the tyre wall, with their inner edges adjacent the rim of the wheel hub. In fact on a conventional wheel, in which the rim stands proud of the adjacent tyre wall, the inner edges of the mask panels can be tucked beneath the rim of the wheel hub, leaving it exposed for painting.

The mask in question has proven highly effective but extended use and development have revealed certain problems. A first problem is experienced during fitting of the mask. In conventional manner it is initially provided with a removable backing covering the adhesive side of the mask panel. Following removal of the backing, the panel proves difficult to handle because it adheres to the fingers of the user. A second problem is that the existing mask is limited in the range of wheel hub diameters which it can accommodate.

### SUMMARY OF THE INVENTION

In accordance with the invention there is provided a mask for use in painting a motor vehicle wheel of the type comprising a hub, which is to be painted and which has an outer rim, and a tyre disposed upon the hub and having a tyre wall, the mask comprising at least two mask panels each having a concave arcuate inner edge so that the mask panels can be arranged together around the wheel hub with their inner edges lying adjacent and conforming to the hub's rim and the mask panels together forming a ring around that rim, covering at least a radially inner region of the tyre wall and so protecting it from inadvertent application of paint, at least a radially inner region of each mask panel being self adhesive and being covered by a removable backing panel so that removing the backing panel exposes the adhesive in this region, enabling the mask panel to be adhered to the tyre wall, but leaves a non-adhesive outer region through which the mask panel is able to be handled by the user during its fitting.

Because the outer region of the mask according to the invention remains non-adhesive even after removal of the backing panel, handling by the user during fitting is facilitated. Also because the radially outer region of the mask is not attached in practice to the tyre wall, it is able to adopt a conical configuration. As a result some limited adjustment becomes possible of the diameter adopted by the inner edge of the mask panels to accommodate a range of wheel hub diameters.

In one preferred embodiment, adhesive is not applied to an entire face of the mask panel. Instead the mask panel carries no adhesive in the said non-adhesive outer region. In such an embodiment a single removable backing panel may be utilised and may cover all or only the adhesive part of the face of the mask panel.

In an alternative embodiment, an entire face of the mask panel is self adhesive and at least two backing panels are provided. The removable backing panel covers the said radially inner region of the mask panel. A second backing panel covers the said outer region. Following removal of the removable backing panel, the second backing panel remains in place, providing the outer region with the non-adhesive surface necessary for it to be conveniently handled.

Preferably the radially inner region of the mask panel through which it is able to be adhered to the tyre wall is shaped as an arcuate band immediately adjacent the arcuate inner edge of the mask panel.

### BRIEF DESCRIPTION OF THE SEVERAL VIEWS OF THE DRAWING

In the accompanying drawings:

FIG. 1 illustrates a mask panel embodying the present invention; and

FIG. 2 shows a motor vehicle wheel with the mask panel being installed.

### DETAILED DESCRIPTION

A mask embodying the present invention will now be described, by way of example only. It comprises a set of self adhesive mask panels 2. Radius of curvature of an arcuate inner edge 4 of the mask panel 2 is chosen to match that of a motor vehicle wheel hub. Several different mask diameters may be offered to the user, who is then required to select the mask appropriate to the diameter of the particular wheel hub to be painted. The shape of the outer edge 6 of the mask panel 2 is less crucial to the product's function, but in this case it too is arcuate. In the illustrated example, the complete mask is to be built up from three separate mask panels 2 each of which describes an arc slightly greater than 120°. Other embodiments could use different numbers of individual mask panels.

The mask is in this case to be applied to a conventional motor vehicle wheel 7 having a metal wheel hub 8 which carries a tyre 10. The invention is however applicable to painting of other types of wheel including, without limitation, spoked vehicle wheels, airplane wheels, trailer wheels etc. A portion of the tyre extending in an approximately radial plane, and seen in FIG. 2 at 12, will be referred to herein as the tyre wall.

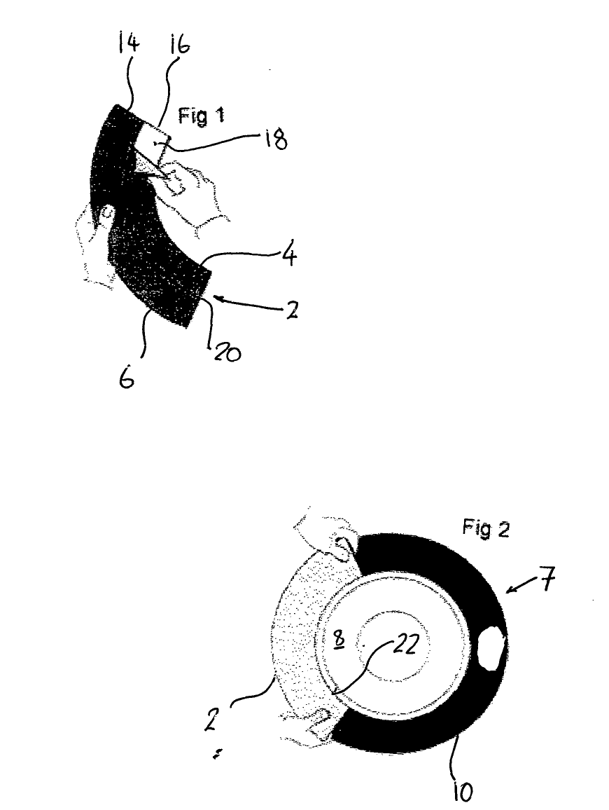

It can be observed in FIG. 1 that the mask panel 2 carries on one of its faces (the foremost face in the drawing) two separate backing panels 14, 16, one radially inboard of the other. The radially inner backing panel 16 is shown partly peeled back to reveal a self adhesive surface 18 of the mask panel itself. The two backing panels 14, 16 are divided along a line 20. The illustrated mask is die cut and the dividing line 20 is referred to as a “kiss cut” by those skilled in the art, since it penetrates the backing but not the mask panel 2 itself.

To apply the mask, following suitable preparation of the tyre and wheel hub, the user begins by peeling away the inner backing panel 16, grasping the mask panel 2 by its outer region which remains non-adhesive due to the presence of the outer backing panel 14. Then, continuing to handle the mask panel 2 through this outer region, the user positions it with its arcuate inner edge 4 adjacent, or more preferably tucked beneath, a rim 22 of the wheel hub. The self adhesive radially inner portion of the mask panel 2 is then smoothed down against the tyre wall 12 and is thereby secured to it. Further mask panels 2 are then applied to mask the entire circumference of the tyre wall 12, overlapping each other to ensure that no gaps are left for intrusion of paint.

Following use the mask can easily be removed by simply peeling away from the tyre wall.

In the illustrated embodiment the mask panels 2 are formed from 250 gsm recycled grey board with a double-sided adhesive film applied. The backing panels 14, 16 are of silicone release paper. However other materials may be used including, without limitation, any suitable paper, card or other flexible sheet material.

It will be appreciated that the above described embodiment serves as example rather than limitation. Numerous modifications are possible without departure from the spirit and scope of the appended claims. For example, whereas in the illustrated embodiment the mask panel 2 carries adhesive upon all of one face, with the two separate (adhesive/non-adhesive) regions of the mask being defined by separate backing panels 14, 16, an alternative would be to apply the adhesive only to the radially inner region of the mask.

1. A mask for use in painting a motor vehicle wheel of the type comprising a hub, which is to be painted and which has an outer rim, and a tire disposed upon the hub and having a tire wall, the mask comprising at least two mask panels each having a concave arcuate inner edge so that the mask panels can be arranged together around the wheel hub with their inner edges lying adjacent and conforming to the hub's rim and the mask panels together forming a ring around that rim, covering at least a radially inner region of the tire wall and so protecting it from inadvertent application of paint, at least a radially inner region of each mask panel being self adhesive and being covered by a removable backing panel so that removing the backing panel exposes the adhesive in this region, enabling the mask panel to be adhered to the tire wall, but leaving a non-adhesive outer region through which the mask panel is able to be handled by the user during its fitting,
wherein one entire face of the mask panel is self adhesive and is covered by at least two backing panels, one of which is the aforementioned removable backing panel and covers said radially inner region and the other of which is a second backing panel and covers a radially outer region, so that the removable backing panel is able to be removed while the second backing panel remains in place to define the non-adhesive outer region.

2. (canceled)

3. A mask as claimed in claim 1 wherein said radially inner region is an arcuate band immediately adjacent the arcuate inner edge of the mask panel.
